(19) United States
(12) Patent Application Publication
(10) Pub. No.: US 2003/0095032 A1
(43) Pub. Date: May 22, 2003

(54) Tag management server

(76) Inventors: Takeshi Hoshino, Kodaira (JP); Manabu Yanagimoto, Sagamihara (JP); Yoshihiro Iwama, Kokubunji (JP); Takashi Yoshimaru, Kokubunji (JP)

Correspondence Address: REED SMITH LLP, Suite 1400, 3110 Fairview Park Drive, Falls Church, VA, 22042, US

(21) Appl. No.: 10/080,577

(22) Filed: Feb. 25, 2002

(30) Foreign Application Priority Data
Nov. 19, 2001 (JP) 2001-353628

(51) Int. Cl. H04Q 1/00

(52) U.S. Cl. 340/5.92; 340/5.74; 340/825.49; 340/572.1; 707/3

(57) ABSTRACT

A tag management server includes a database for storing tag management information corresponding to respective ID tags, wherein the tag management server judges whether the inquiry is legitimate or not, based on tag information corresponding to an ID tag managed by the tag management server, the tag management server retrieves tag management information corresponding to the tag information used in the legitimate inquiry from the database, and when the corresponding tag management information is retrieved, the tag management server supplies the tag management information to an inquirer, and when the inquiry is not legitimate or when corresponding tag management information is not retrieved, the tag management server gives a notice of the fact to the inquirer.

### BACKGROUND OF THE INVENTION

The present invention relates to a tag management server by which information about articles or the like can be acquired on the basis of information from electronic tags attached to the articles, and an information acquiring/utilizing system using the tag management server.

A technique using bar codes has come into wide use as the technique for identifying articles. This bar code is a combination of a plurality of wide and narrow bars aligned in one line and attached to an item for sale (hereinafter referred to as “commercial item”) for revealing information such as its item number or the like. Such bar codes are very cheep, but a reader for reading information from the bar codes has to be pressed on the bar codes in order to read the information. In addition, there is also a problem that the amount of information revealed by such bar codes is small. To solve the problem in the amount of information, there have been proposed two-dimensional bar codes in which dots are used instead of bars, and information is revealed by the arrangement of a plurality of dots. A two-dimensional sensor such as a video camera is used for reading the two-dimensional bar codes. However, even if such two-dimensional bar codes are used, a reader has to be pressed on the two-dimensional bar codes or made extremely close thereto in order to read information therefrom.

On the other hand, there have been proposed so-called electronic tags such as RF-ID (Radio Frequency Identification) tags from which information can be read at some distant positions. Such a tag has a very small IC (Integrated Circuit) chip into which a very small antenna is integrated, and information is stored in this IC chip. As soon as the IC chip receives a radio wave from the antenna, the IC chip operates by its own power supply voltage formed from the received signal, and transmits the stored information through the antenna. Thus, even if the reader is distant from the electronic tag to some extent, the reader can read the information of the electronic tag simply by transmitting a radio wave to the electronic tag.

If the transmitted radio wave from such an electronic tag can be received, the information of the electronic tag can be read. Thus, the information can be read by the reader even if the reader is distant from the electronic tag. Usually, the information can be read even if the reader is about 1 m distant from the electronic tag. Further, such information reading will go well if the electronic tag can transmit a radio wave having enough intensity to be detected by the reader. Thus, the electronic tag can be made small enough to be nearly invisible to naked eyes. In addition, the electronic tag is superior in properties against environment such as water or dust. In short, the electronic tag is unimposing particularly without causing any problem even if the electronic tag is left to be attached to a purchased commercial item.

In addition, rewritable EEPROMs are used as information storage elements in electronic tags. Some EEPROMs have a storage capacity ranging from about several bytes to about several kilobytes. Thus, not only ID codes but also various kinds of information can be stored. That is, information required in accordance with the use can be stored in the electronic tag. Further, there is an advantage that information can be rewritten, while the information stored once can be saved for a long term and used repeatedly. In addition, the information can be read at a high speed. ID codes can be read from about 50 electronic tags per second, and information can be read from electronic tags moving at a speed as high as persons go at a run.

### SUMMARY OF THE INVENTION

Generally, such bar codes or electronic tags are provided for commercial items to be sold in stores or the like. Customers determine their desired items in such stores or the like, and such bar codes or electronic tags are used for salespersons to acquire information about the commercial items.

As customers, we are interested in and desire commercial items when they are on sale in stores or the like. In most cases, however, we may be also interested in the possessive items worn or used by others and desired to have commercial items the same as the possessive items. On the other hand, we also know that an item when it is being used may give us a different impression from an impression when the same item is being displayed in a store. Under such a condition, we want to know where the item is made or where the item is being sold. It is, however, impossible to ask a stranger about information of the stranger's possessive item if the stranger wears or uses it. Even if it is possible to ask, it is still difficult for us to acquire exact information because the information we can get depends on the knowledge or memory of the person possessing the item.

It is an object of the invention to provide a tag management server by which information about desired articles can be acquired easily regardless of place, and an information acquiring/utilizing system using the tag management server.

To attain the foregoing object, a tag management server according to the invention provides tag management information corresponding to tag information read from an ID tag in response to an inquiry using the tag information. The tag management server has a database for storing tag management information corresponding to respective ID tags. The tag management server judges whether the inquiry is legitimate or not based on tag information corresponding to a managed ID tag. The tag management server retrieves, from the database, tag management information corresponding to the tag information in response to the inquiry made legitimately. When the corresponding tag management information is retrieved, the tag management server supplies the tag management information to the inquirer. If the inquiry is not legitimate or if the corresponding tag management information is not retrieved, the tag management server gives a notice of the fact to the inquirer.

In addition, the tag management information for every ID tag managed includes a maker and a trade name of an article provided with the ID tag.

To attain the foregoing object, an information acquiring/utilizing system according to the invention includes a portable terminal for reading tag information from ID tags provided in articles by radio waves, the tag management server defined above, and an item management server. The portable terminal makes an inquiry to the tag management server on the basis of tag information read from an ID tag. In response to this inquiry from the portable terminal, the tag management server supplies corresponding tag management information to the portable terminal. The portable terminal makes an inquiry to the item management server on the basis of the tag management information acquired from the tag management server. In response to this inquiry from the portable terminal, the item management server supplies the portable terminal with item information about the article provided with the ID tag whose tag information is acquired by the portable terminal.

In addition, the portable terminal has an antenna with directivity for reading tag information from an ID tag.

Alternatively, the portable terminal has an antenna with nondirectivity for reading tag information from ID tags. In this case, the portable terminal has an operating button for reading tag information from ID tags. When this operating button is operated, tag information of ID tags existing within a predetermined distance is read for a predetermined time. Alternatively, the portable terminal has an operating button for reading tag information from ID tags so that the portable terminal reads tag information from ID tags existing within a predetermined distance during the period when this operating button is in an operating state.

Other objects, features and advantages of the invention will become apparent from the following description of the embodiments of the invention taken in conjunction with the accompanying drawings.

### BRIEF DESCRIPTION OF THE DRAWINGS

FIG. 1 is a structural view showing a first embodiment of a tag management server and an information acquiring/utilizing system using the tag management server according to the present invention;

FIG. 2 is a diagram showing specific examples of respective pieces of information in the embodiment shown in FIG. 1;

FIG. 3 is a block diagram showing a specific example of the circuitry of a portable terminal;

FIGS. 4A, 4B and 4C are plan views showing a specific example of the front face of the portable terminal in FIG. 3;

FIGS. 5A and 5B are views showing a use mode of the portable terminal when the portable terminal reads tag information;

FIG. 6 is a flow chart showing a specific example of the operating procedure of the portable terminal when the portable terminal reads tag information;

FIG. 7 is a view showing specific examples of screens displayed in a display screen in the operating procedure;

FIG. 8 is a flow chart showing a specific example of the operation of the tag management server;

FIGS. 9A and 9B are structural views showing a specific example of a portable terminal in a second embodiment of a tag management server and an information acquiring/utilizing system using the tag management server according to the present invention;

FIG. 10 is a view showing a specific example of an ID reading antenna used in the portable terminal;

FIGS. 11A and 11B are views showing another specific example of an ID reading antenna used in the portable terminal;

FIG. 12 is a flow chart showing a specific example of the operating procedure of the portable terminal shown in FIGS. 9A and 9B for reading tag information;

FIGS. 13A and 13B are tables schematically showing specific examples of a continuous database and a one-shot database stored in the portable terminal;

FIG. 14 is a flow chart showing a specific example of the operating procedure of the portable terminal for acquiring item information by use of the one-shot database in the portable terminal;

FIG. 15 is a view showing specific examples of screens displayed in the display screen of the portable terminal in the operating procedure;

FIG. 16 is a flow chart showing a specific example of the operating procedure of the portable terminal for acquiring item information by use of the continuous database in the portable terminal;

FIGS. 17A, 17B, 17C, 17D, 17E, 17F, 17G, 17H are views showing specific examples of screens displayed in the display screen of the portable terminal in the operating procedure; and

FIGS. 18A and 18B are views showing specific examples of management systems using the portable terminal.

### DESCRIPTION OF THE EMBODIMENTS

Embodiments of the present invention will be described below with reference to the drawings.

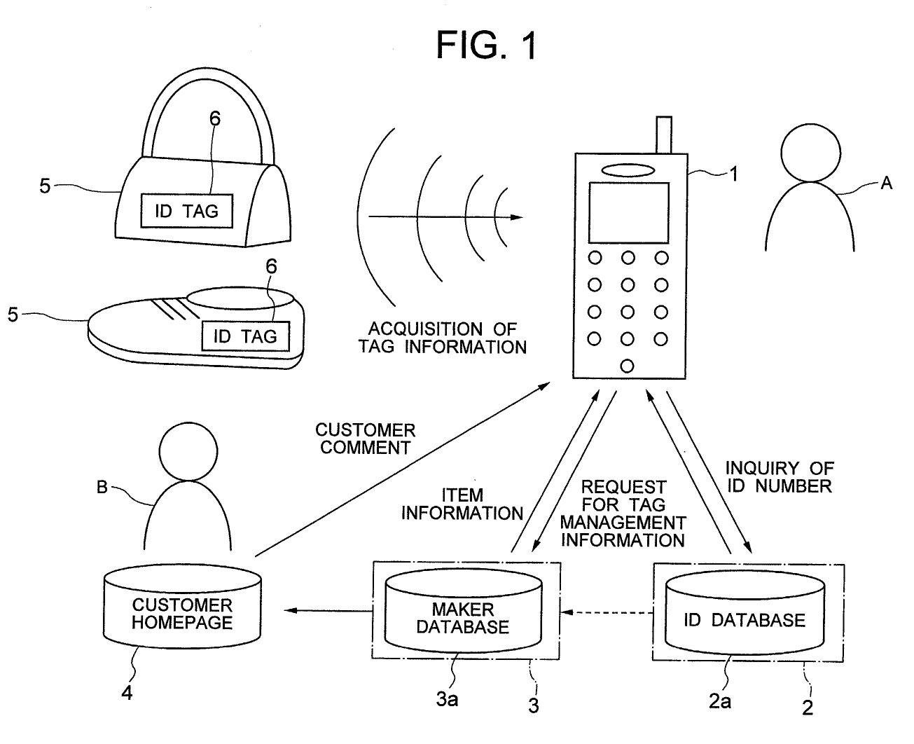

FIG. 1 is a structural view showing an embodiment of a tag management server and an information acquiring/utilizing system using the tag management server according to the present invention. In FIG. 1, the reference numeral 1 represents a cellular phone; 2, a tag management server; 2a, an ID database; 3, an item management server; 3a, a maker database; 4, a customer homepage; 5, an article; and 6, an ID (Identification) tag. Incidentally, the cellular phone 1 will be described below by way of example. This embodiment is not limited to the cellular phone, but other portable terminals may be used.

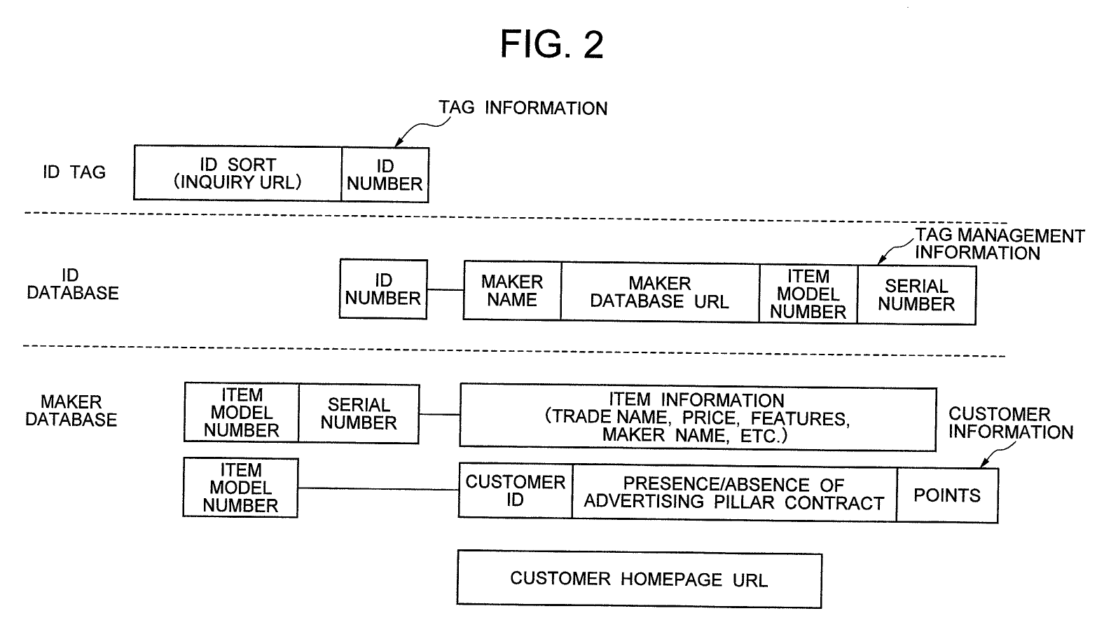

In FIG. 1, in the system according to this embodiment, each article 5 is provided with an ID tag 6. Such articles 5 may be items on sale in dealers such as shops or department stores, or may be worn or carried by persons. Further, the articles 5 may be disposed indoors or outdoors. The ID tag 6 is an electronic tag such as the RF-ID tag, provided with an antenna and an IC (Integrated Circuit). This IC stores an ID (Identification) number and an ID sort (inquiry URL (Uniform Resource Locator) of the tag management server 2) peculiar to the article for identifying the article as shown in FIG. 2. A peculiar ID number is assigned to the article 5. The assigned ID number does not overlap the ID number of any other article 5. Such an ID number is stored in the ID tag 6 of the article 5 corresponding to the ID number.

The cellular phone 1 is designed to be able to communicate with such ID tags 6 of articles 5 via radio waves. The cellular phone 1 is also designed to be able to communicate with the tag management server 2, the item management server 3 and the customer homepage 4 via a network such as the Internet. For example, when the portable terminal 1 is made to communicate with an ID tag 6 of a desired article 5, a radio wave is outputted from the portable terminal 1 toward the ID tag 6 of the article 5 by a predetermined operation which will be described later. When the ID tag 6 receives the radio wave, the IC generates a power supply voltage from the received radio wave. The IC operates by the generated power supply voltage so as to transmit tag information constituted by the stored ID number and the stored inquiry URL of the tag management server 2 stored therein. This tag information is received by the portable terminal 1.

Since radio communication is carried out between the portable terminal 1 and the ID tag 6 in such a manner, the portable terminal 1 can acquire tag information while keeping a certain distance from the ID tag 6. When the article (item) 5 is on sale and has the ID tag 6 already attached to the article 5, the ID tag 6 is small enough to be unimposing. Further, if such an ID tag 6 is attached to an obscure place in the item 5, the ID tag 6 is not necessarily removed even at the time of being solded.

The tag management server 2 is a server of a management company managing the ID tags 6. The tag management server 2 has an ID database 2a storing information (tag management information) for managing the ID tags 6. When the ID tags 6 are managed by a plurality of management companies, such a tag management server 2 is provided in each of the management companies. When the portable terminal 1 acquires tag information from a given ID tag 6 in the aforementioned manner, the portable terminal 1 uses the tag information to make an inquiry about the ID number to the tag management server 2 managing the ID tag 6 whose the tag information was acquired by the portable terminal 1. The inquiry URL of the tag management server 2 stored in the ID tag 6 designates the tag management server 2 managing the ID tag 6. Such an inquiry URL is set for every tag management server 2.

As shown in FIG. 2, in the ID database 2a, tag management information is stored for every ID number of ID tags 6 managed by the tag management server 2. The tag management information is constituted by a maker name of the article 5 to which the ID tag 6 is attached, a maker database URL designating an item management server 3 managing the article 5, an item number or a serial number of the article 5 provided in the ID tag 6, and so on.

When there is an inquiry from the portable terminal 1 via the inquiry URL, the tag management server 2 first reads tag management information corresponding to the inquired ID number from the ID database 2a, and sends the tag management information to the portable terminal 1 which is the inquirer. In the portable terminal 1, of the tag management information, the maker name, the item model number, and so on, are displayed. Thus, an owner (hereinafter, referred to as “terminal owner”) “A” of the portable terminal 1 can know the maker and so on of the article 5 from which the tag information was read. When the terminal owner “A” viewing such displayed information carries out a predetermined instructive operation via the portable terminal 1, an inquiry about the item model number and the serial number is made by the portable terminal 1 to the item management server 3 designated by the maker database URL. Alternatively, the system may be designed as follows. That is, in response to an inquiry from the portable terminal 1, of the tag management information, the maker name and the item model number are sent from the tag management server 2 to the portable terminal 1 and displayed in the portable terminal 1. When the terminal owner “A” viewing this display operates the portable terminal 1 so as to send a request for item information to the tag management server 2, the tag management server 2 designates a corresponding item management server 3 with a maker database URL in the tag management information in response to the request from the portable terminal 1. Then, an inquiry about the item model number and the serial number corresponding to the ID number inquired is made by the portable terminal 1 to the item management server 3. The maker database URL in the tag management information is set for every item management server 3, and is peculiar to the item management server 3.

The item management server 3 has a database (maker database) 3a in which information about items (that is, item information) such as trade names, prices, features, maker names, selling agencies, etc., of articles (items) dealt with by the maker itself is stored in association with item model numbers or serial numbers of the articles. Here, examples of makers may include selling agencies such as department stores or chain stores as well as makers of articles, trading companies importing articles, or the like.

When such an inquiry is made by the tag management server 2, the item management server 3 reads, from the maker database 3a, item information corresponding to the item model number and the serial number inquired, and sends the item information to the portable terminal 1 which is an inquirer. This item information is displayed in the display screen in the portable terminal 1 so that the terminal owner “A” viewing the item information can know information about the article 5 from which the tag information was read.

Further, for every item model number of articles dealt with by this maker, the maker database 3a stores information about customers who have purchased articles of this item model number, that is, information such as customer IDs, presence or absence of advertising pillar contracts of the customers, points awarded to the customers, and so on (that is, customer information). Such points are awarded to any customer whose customer information has been registered about this item model number when the terminal owner “A” acquires the aforementioned information (tag management information from the tag management server 2 or item information from the item management server 3) of an item dealt with by this maker or purchases the item. When the customer purchases an item, the customer can enjoy an advantage such as discount through the points. In addition, the scale of points awarded can be changed in accordance with the existence of the advertising pillar contract.

Further, the item management server 3 provides new information about items (for example, item information added newly to the maker database 3a ) to a customer (hereinafter, referred to as “contract customer”) “B” having an advertising pillar contract with the maker, on a customer homepage 4 of the contract customer “B”. Therefore, the maker database 3a of the item management server 3 also stores the customer homepage URL for gaining access to such a customer homepage 4.

This customer homepage 4 is open to the public so that anyone can access the customer homepage 4. In addition, the contract customer “B” creates information about a purchased item as a target of the advertising pillar contract (for example, use conditions of the item or impressions of the item), and registers the information in this customer homepage 4 so that other customers can use the information as reference information when they purchases similar items. Such a customer homepage 4 may be established on customer's own accord, or may be established by use of the item management server 3 or the like.

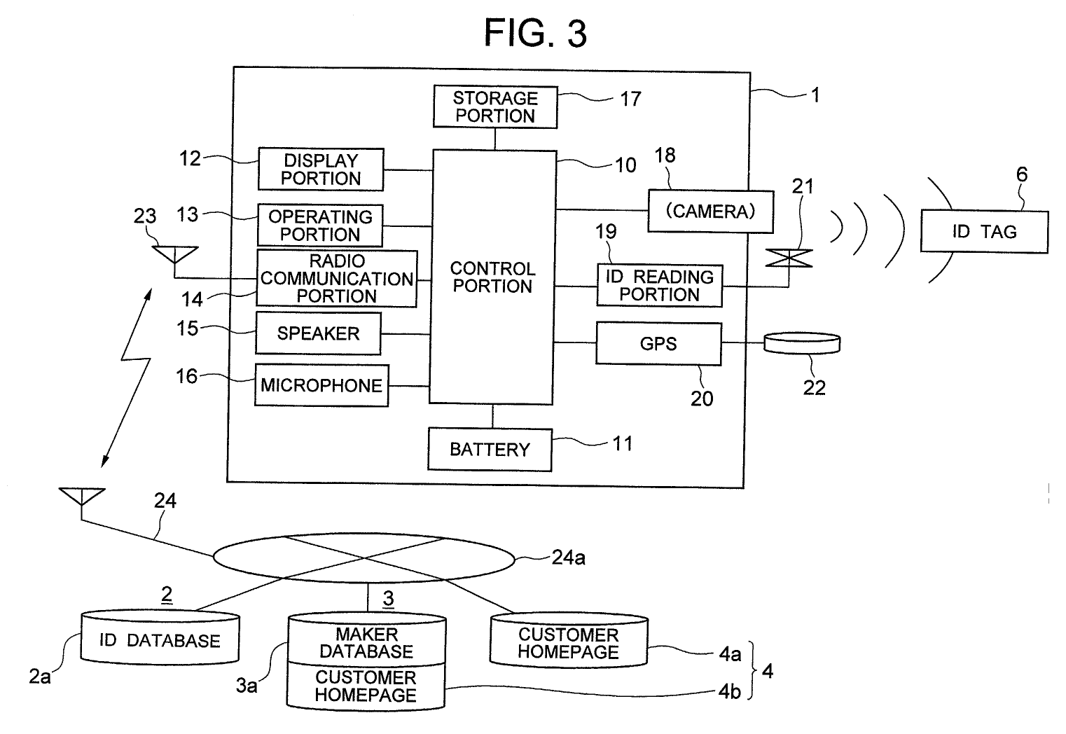

FIG. 3 is a block diagram showing a specific example of the circuitry of the portable terminal 1 in FIG. 1. In FIG. 3, the reference numerals 4a and 4b represent customer homepages; 10, a control portion; 11, a battery; 12, a display portion; 13, an operating portion; 14, a radio communication portion; 15, a speaker; 16, a microphone; 17, a storage portion; 18, a video camera; 19, an ID reading portion; 20, a GPS (Global Positioning System); 21, an ID reading antenna; 22, a GPS antenna; 23, a radio communication antenna; 24, a public radio communication network; and 24a, the Internet. Parts equivalent to those in FIG. 1 are referenced correspondingly, and repeated description will be omitted.

In FIG. 3, here, the portable terminal 1 is regarded as a cellular phone. In the same manner as background-art cellular phones, the cellular phone 1 uses the battery 11 as a power source, and includes the display portion 12, the operating portion 13, the speaker 15, the microphone 16, the radio communication antenna 23 and the radio communication portion 14 for connecting the cellular phone 1 with the Internet 24a through the public radio communication network 24. The portable terminal 1 further includes the ID reading antenna 21, the ID reading portion 19 and the video camera 18 for reading tag information from ID tags 6. The cellular phone 1 is also provided with the GPS 20 and the GPS antenna 22 for guiding the terminal owner “A” on a map through the display portion 12. These members are controlled by the control portion 10 in accordance with the operation of the operating portion 13.

When the terminal owner “A” (FIG. 1) makes a predetermined operation through the operating portion 13 in order to read tag information from the ID tag 6, the control portion 10 controls the ID reading portion 19 so as to transmit a radio wave from the ID reading antenna 21 having directivity. When the ID reading antenna 21 is directed to the ID tag 6, the radio wave transmitted from the ID reading antenna 21 is received by the ID tag 6. The ID tag 6 receiving this radio wave transmits tag information as described above. The transmitted tag information is received by the ID reading antenna 21, and read by the ID reading portion 19. Under the control of the control portion 10, as soon as the tag information is stored in the storage portion 17, the tag information is transmitted from the radio communication antenna 23 by the radio communication portion 14. Thus, the tag information is sent to the tag management server 2 through the public radio communication network 24 and the Internet 24a.

Alternatively, the tag information read by the ID reading portion 19 may be once stored and retained in the storage portion 17 under the control of the control portion 10 (at this time, an icon indicating that the tag information has been read is displayed in the display portion 12). In this case, in response to an operation through the operating portion 13, the retained tag information is transmitted from the radio communication portion 14 through the radio communication antenna 23.

Further, a video signal picked up by the video camera 18 is subjected to predetermined processing and then displayed in the display portion 12. The view field direction (image picking up direction) of the video camera 18 is substantially in agreement with the pointing direction of the ID reading antenna 21. Accordingly, when the ID tag 6 is to be read, the direction of the ID tag 6 can be confirmed by use of the video camera 18. Thus, even if the ID reading antenna 21 is distant from the ID tag 6, the pointing direction of the ID reading antenna 21 can be directed to the ID tag 6 accurately.

The tag management server 2 receiving the tag information reads tag management information corresponding to the ID number of the tag information from the ID database 2a, and transmits the tag management information to the cellular phone 1 through the Internet 24a and the public radio communication network 24. In the cellular phone 1, when the tag management information is received by the radio communication portion 14, under the control of the control portion 10, the tag management information is stored in the storage portion 17, and the maker name and the item model number of the article provided with the read ID tag 6 are displayed in the display portion 12 on the basis of the tag management information.

When the terminal owner “A” viewing the display contents of the display portion 12 further makes a predetermined operation through the operating portion 13 so as to make a request for detailed information of the article, a corresponding item management server 3 is designated by use of a maker database URL in the tag management information stored in the storage portion 17. Thus, an inquiry about the item model number and the serial number of the tag management information is made from the radio communication portion 14 to the designated item management server 3 through the radio communication antenna 23, the public radio communication network 24 and the Internet 24a.

Incidentally, the maker name and the item model number of the tag management information may be sent from the tag management server 2 to the portable terminal 1 and displayed in the portable terminal 1 as described above. In this case, when the terminal owner “A” viewing the display contents of the display portion 12 further makes a predetermined operation through the operating portion 13 so as to make a request for detailed information of the item, the portable terminal 1 uses an inquiry URL in the tag information stored in the storage portion 17 so as to send this request to the tag management server 2. In response to the request, the tag management server 2 designates a corresponding item management server 3 by use of the maker database URL in the tag management information, and makes an inquiry about the item model number and the serial number of the requested tag management information to the designated item management server 3 through the Internet 24a.

In response to this inquiry, the item management server 3 reads item information corresponding to the item model number and the serial number from the maker database 3a, and transmits the item information to the cellular phone 1 through the Internet 24a and the public radio communication network 24. In the cellular phone 1, the item information is received by the radio communication portion 14 through the radio communication antenna 23, once stored in the storage portion 17, and then displayed in the display portion 12.

Incidentally, by a predetermined operation through the operating portion 13, the terminal owner “A” can gain access to the customer homepages 4a and 4b of customers under contracts on the Internet 24a so as to acquire introductory information of the item or the like.

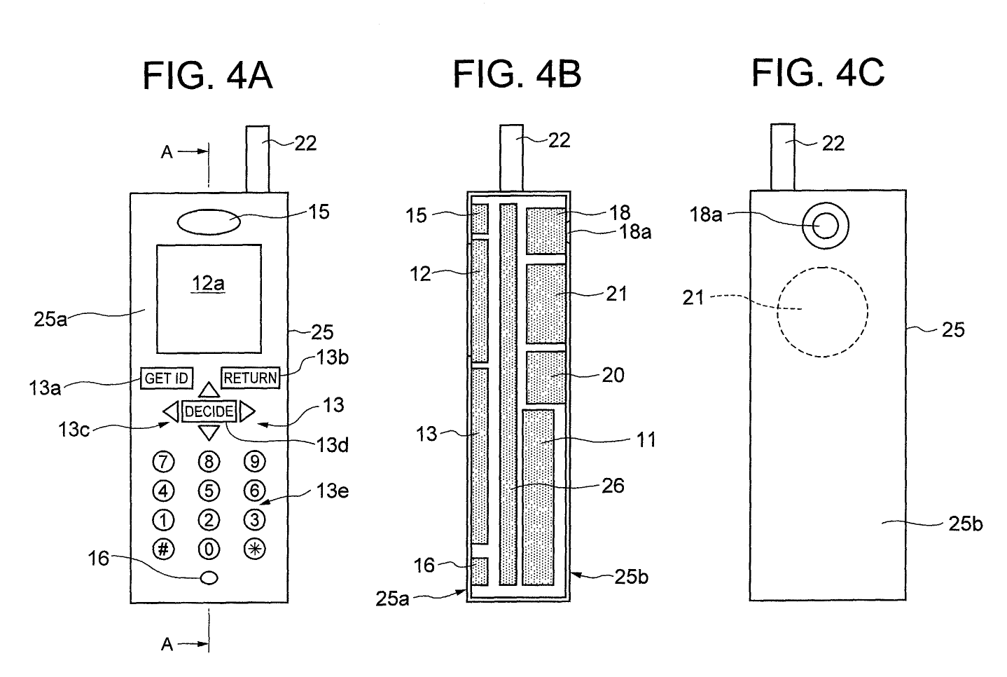

FIGS. 4A, 4B and 4C are views showing an example of the configuration of the portable terminal 1 in FIG. 3. Here, the portable terminal 1 is formed as a cellular phone. FIG. 4A is a front view; FIG. 4B is a sectional view taken on line A-A in FIG. 4A; and FIG. 4C is a back view. In FIGS. 4A to 4C, the reference numeral 12a represents a display screen; 13a, an ID acquiring button; 13b, a return button; 13c, a cursor button; 13d, a decision button; 13e, a dial button; 18a, a camera lens; 25, a housing; 25a, a front face; 25b, a back face; and 26, a circuit board. Parts equivalent to those in FIG. 3 are referenced correspondingly, and repeated description thereof will be omitted.

As shown in FIG. 4A, the speaker 15, the display screen 12a of the display portion 12, the operating portion 13, and the microphone 16 are disposed in the front face 25a of the housing 25 of the cellular phone 1 in the ascending order of the distance from FIG. 4A. This operating portion 13 is provided with operating buttons for reading tag information, such as the ID acquiring button 13a, the return button 13b, the cursor button 13c, the decision button 13d and the dial button 13e. Here, though not shown, it is a matter of course that operating buttons usually provided in cellular phones for telephone call, electronic mail and Internet connection are also provided. Further, the camera lens 18a of the video camera 18 can be seen in the back face 25b of the housing 25.

In addition, inside the housing 25, the circuit board 26 is provided at the substantially central portion of the inside of the housing 25 so as to extend from the upper side of the housing 25 to the lower side thereof as shown in FIG. 4B. Then, the speaker 15, the display portion 12, the operating portion 13 and the microphone 16 are disposed respectively more closely to the front face 25a than to the circuit board 26. On the other hand, the video camera 18 with the camera lens 18a, the ID reading antenna 21, the GPS 20, the GPS antenna 22, and the battery 11 are disposed respectively more closely to the back face 25b than to the circuit board 26. Incidentally, the control portion 10, the radio communication portion 14 and the ID reading portion 19 shown in FIG. 3, other not-shown circuit portions, and the storage portion 17 are mounted on the circuit board 26. The video camera 18 and the ID reading antenna 21 are disposed closely to each other. Incidentally, since the ID reading antenna 21 is provided inside the housing 25, the ID reading antenna 21 is illustrated by the broken line on the back face 25b shown in FIG. 4C. By this illustration, it is shown that the video camera 18 and the ID reading antenna 21 are disposed closely to each other.

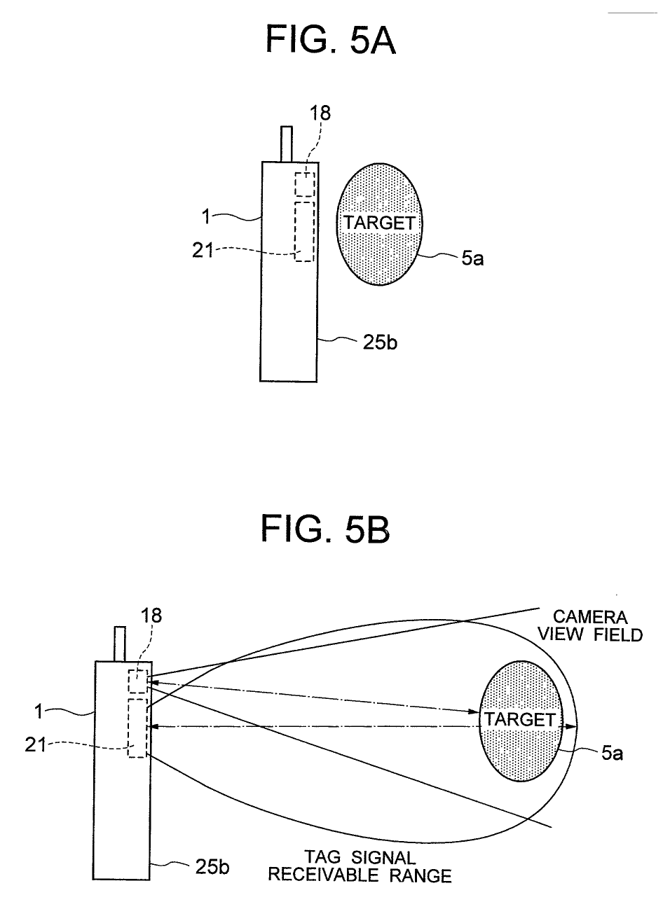

FIGS. 5A and 5B are views showing a use mode when tag information is read from the ID tag 6 by use of the cellular phone 1 configured as shown in FIGS. 3, 4A, 4B and 4C. FIG. 5A shows the case where tag information is read at a short distance from the ID tag 6, and FIG. 5B shows the case where tag information is read at a long distance from the ID tag 6.

As shown in FIG. 5A, when tag information is read while the ID reading antenna 21 is made close to a target 5a (incidentally, the target 5a may be an article 5 or a partial area of the article 5) including the ID tag 6, for example, within a range of several cm, the terminal owner “A” (FIG. 1) makes the cellular phone 1 directly close to this target 5a. Thus, the terminal owner “A” does not have to use the video camera 18.

Incidentally, since the ID tag 6 is very small, it is often difficult to find out to which area of the article 5 the ID tag 6 is attached. However, the terminal owner “A” may make the cellular phone 1 close to the article 5 when the terminal owner “A” is interested in a certain article 5. Accordingly, tag information transmitted from an ID tag 6 can be read without confirming where the ID tag 6 is, if there is the ID tag 6 within the receivable range of the ID reading antenna 21.

In this embodiment, now, if the ID acquiring button 13a in the operating portion 13 as shown in FIGS. 4A is operated, a radio wave is transmitted from the ID reading antenna 21. When the ID tag 6 receives this radio wave, the ID tag 6 transmits the tag information as described above, and the ID reading antenna 21 receives the tag information. When the ID reading antenna 21 receives and reads the tag information in such a manner, information (such as an icon) indicating the message of the tag information is displayed in the display screen 12a of the display portion 12 (FIG. 4A).

However, in this embodiment, the directivity of the ID reading antenna 21 for reading tag information from one ID tag 6 is set to be narrow. Therefore, there may be a case that if the terminal owner “A” simply makes the back face 25b of the cellular phone 1 close to an article 5 the terminal owner “A” is interested in, the ID tag 6 attached to the article 5 does not fall in the receivable range of the ID reading antenna 21. However, when the ID acquiring button 13a in the operating portion 13 is operated, information such as an icon indicating whether tag information has been read or not is displayed in the display screen 12a as described above. Accordingly, when it is found that tag information has not been read, the back face 25b of the cellular phone 1 may be made close to the article 5 so as to direct the ID reading antenna 21 toward another area of the article 5. In such a condition, the tag information reading operation can be tried again.

When tag information is to be read at a certain distance from a target 5a, the video camera 18 can be used to confirm the target 5a. An image picked up by the video camera 18 is displayed in the display screen 12a (FIG. 4A) of the display portion 12. Then, as shown in FIG. 5B, the directivity of the ID reading antenna 21 and the view field property of the video camera 18 are set so that the radio wave transmitting/tag information receiving range of the ID reading antenna 21 and the view field range of the video camera 18 are substantially in agreement with each other in a position where the back face 25b of the cellular phone 1 is at a predetermined distance (for example, about 1 to 2 m). Thus, when the cellular phone 1 is to read tag information of the ID tag 6 at a distance from the target 5a, the back face 25b of the cellular phone 1 may be directed to the target Sa so that an image of the target 5a picked up by the video camera 18 is displayed in the display screen 12a (that is, the target 5a is confirmed). Then, the ID acquiring button 13a (FIG. 4A) is operated to read tag information.

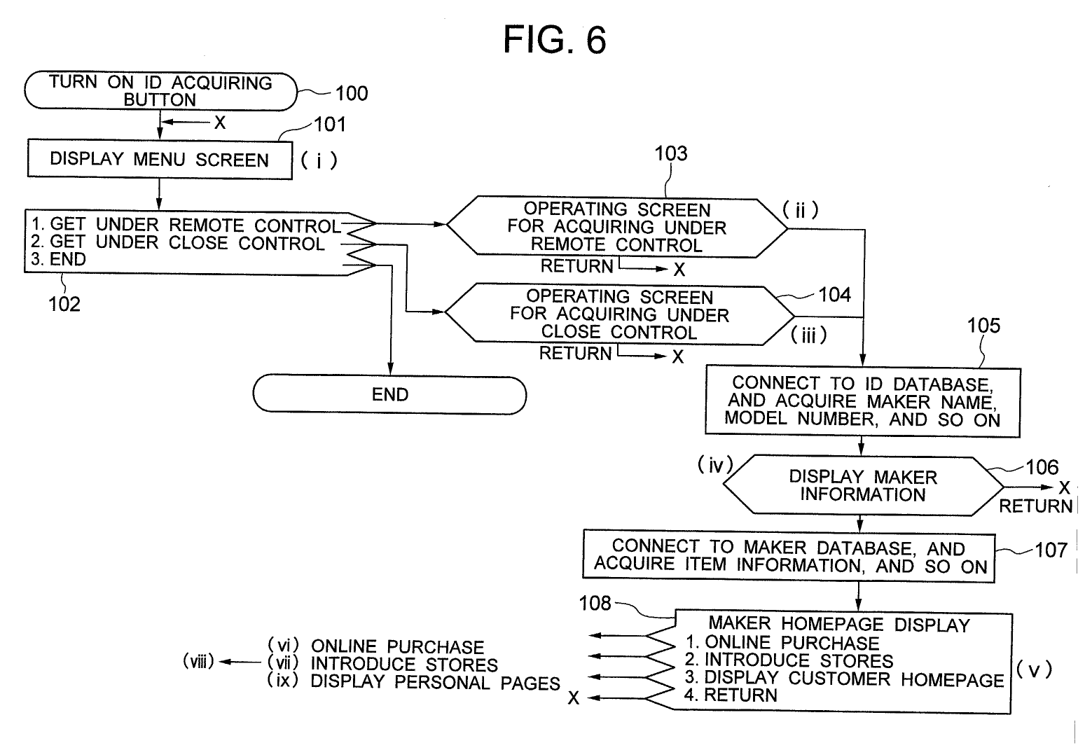

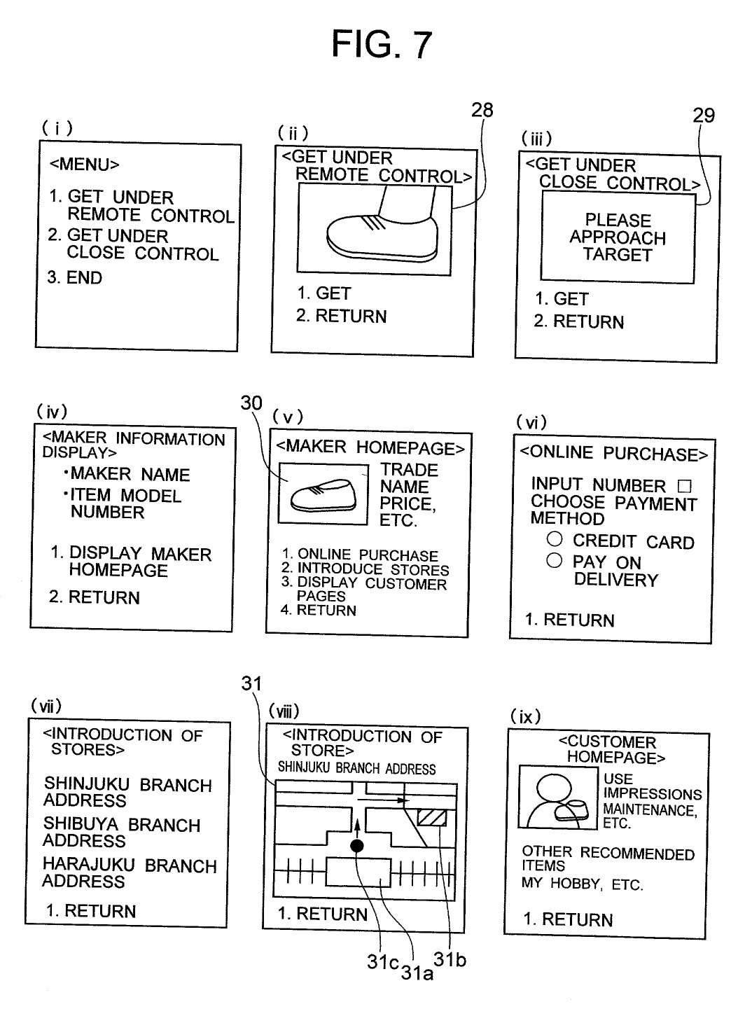

Next, with reference to FIGS. 6 and 7, description will be made on an operating procedure for reading tag information by the cellular phone 1 shown in FIGS. 4A, 4B and 4C, and specific examples of screens displayed in the display screen 12a in the operating procedure. Incidentally, FIG. 6 is a flow chart showing this operating procedure, and FIG. 7 is a view showing screens displayed in accordance with operations. The displayed screens are referenced by the reference numerals (i), (ii), (iii), . . . , and screens corresponding to respective operations are represented by such reference numerals in FIG. 6. In addition, in FIG. 7, the reference numeral 28 represents a photographic screen; 29, a guide screen; 30, an item screen; and 31, a store guide screen.

In FIGS. 6 and 7, when the ID acquiring button 13a (FIG. 4A) in the operating portion 13 of the cellular phone 1 is now operated (Step 100), a tag reading mode is established, and a menu screen (i) is displayed in the display screen 12a (FIG. 4A) (Step 101). One of menu items in this menu screen (i) can be chosen. That is, the menu includes a menu item “1. get under remote control” for reading tag information of the ID tag 6 (FIG. 1) at a distance from the target 5a as shown in FIG. 5B, a menu item “2. get under close control” for reading tag information of the ID tag 6 at a short distance from the target 5a as shown in FIG. 5A, and a menu item “end” for releasing the tag reading mode. Such a menu item can be chosen by operating the dial button 13e (FIG. 4A) of the operating portion 13 corresponding to the digits 1, 2 and 3 added to the menu items. Alternatively, the cursor button 13c and the decision button 13d in the operating portion 13 may be used to operate a not shown cursor so as to designate and decide a menu item. The same rule can be applied to menu items added with digits in respective menus in the other screens (ii) to (ix) shown in FIG. 7.

When the menu item “1. get under remote control” is chosen in the menu screen (i) (Step 102), a remote control choice screen (ii) is displayed in the display screen 12a. In this remote control choice screen (ii), the photographic screen 28 displaying an image of an object picked up presently by the video camera 18 (FIGS. 4C and 5B) is displayed. In addition, a menu of menu items “1. get” and “2. return” is displayed. In the state where the remote control choice screen (ii) is displayed, the direction of the back face 25b of the cellular phone 1 is set so that the target 5a (FIG. 5A) is displayed in the photographic screen 28 as described in FIG. 5B. When the menu item “1. get” is then chosen (Step 103), the routine of process goes to Step 105.

On the other hand, when the menu item “2. get under close control” is chosen in the menu screen (i) (Step 102), a close control choice screen (iii) is displayed in the display screen 12a. In this close control choice screen (iii), for example, the guide screen 29 indicating “Please approach target” is displayed. In addition, a menu of menu items “1. get” and “2. return” is displayed in the guide screen 29 in the same manner as that in the remote control choice screen (ii). The back face 25b of the cellular phone 1 is made to approach the target 5a in accordance with this guidance. When the menu item “1. get” is then chosen (Step 104), the routine of process goes to Step 105.

Incidentally, when the menu item “2. return” is chosen either in the remote control choice screen (ii) or in the close control choice screen (iii) (likewise when the return button 13b in the operating portion 13 is operated alternatively in this case), the routine of process returns to Step 101 so that the display state is brought back to the menu screen (i). On the other hand, when the menu item “3. end” is chosen in this menu screen (i), the tag reading mode is released.

When the menu item “1. get” is chosen in the remote control choice screen (ii) or in the close control choice screen (iii) (Step 103 or 104), tag information is acquired from the ID tag 6 (FIG. 1) as described in FIG. 1. When an inquiry is made to the tag management server 2 (FIG. 1) by use of this tag information, tag management information corresponding to the ID number of the tag information can be acquired (Step 105). As a result, a maker display screen (iv) is displayed in the display screen 12a (Step 106). In this maker display screen (iv), the maker name and the item model number of the article provided with the ID tag 6 from which the tag information was read are displayed. In addition, a menu of menu items “1. display maker homepage” and “2. return” is displayed so that the menu items can be chosen.

When the menu item “2. return” is chosen in this maker display screen (iv), the routine of process returns to Step 101 so that the display state is brought back to the menu screen (i). On the other hand, when the menu item “1. display maker homepage” is chosen, an inquiry is made to the item management server 3 as described in FIG. 1. Thus, image information indicating item information corresponding to the item model number and the serial number of the tag management information from the tag management server 2 can be acquired from the item management server 3 (Step 107), and a maker homepage screen (v) is displayed in the display screen 12a (Step 108). In this maker homepage screen (v), the item screen 30 of this item (article) together with item information such as trade name, maker name, price, and features such as ingredients, material or color, of the item corresponding to the item model number and the serial number are displayed so that the terminal owner “A” can know the item in detail.

In addition, in this maker homepage screen (v), a menu of menu items “1. online purchase”, “2. introduce stores”, “3. display customer homepage” and “4. return” is displayed so that one of the menu items can be chosen.

When the terminal owner “A” viewing such item information desires to buy this item, the terminal owner “A” chooses the menu item “1. online purchase”. Then, an online purchase screen (vi) is sent from the item management server 3 and displayed in the display screen 12a. In this online purchase screen (vi), an input column for the quantity of the items to be purchased is provided, and payment by credit card or payment on delivery can be chosen as a manner to make the payment. By inputting a number into the input column for the quantity of items to be purchased and choosing the manner to make the payment (or by further operating the decision button 13d of the operating portion 13), the items model number and the item information as well as such input and choice information are sent to the maker so that a purchasing contract between the terminal owner “A” and the maker can be made online. Further, the online purchase screen (vi) may be arranged to allow the terminal owner “A” to determine whether the terminal owner A wants an advertising pillar contract or not.

On the other hand, when the menu item “2. introduce stores” in the maker homepage screen (v) is chosen, introduction image information is sent from the item management server 3, and a store introduction screen (vii) is displayed in the display screen 12a. In this store introduction screen (vii), names, addresses, closest stations and so on of stores selling this item are displayed. These store names and so on may be arrayed at random. However, since the cellular phone 1 has the GPS 20 (FIG. 3), the store names and so on may be arrayed in the ascending order of the distance from the position of the GPS 20 (that is, the terminal owner “A”) detected by the GPS 20 itself. When a certain store (for example, Shinjuku Branch) is chosen in the store introduction screen (vii), image information for introducing the position of the store is sent from the item management server 3, and a store guidance screen (viii) is displayed. In this store guidance screen (viii), for example, a map 31 showing the route from a landmark 31a indicating a remarkable facility such as a closest station to the store 31b is displayed. When the position 31c of the cellular phone 1 is in this map 31, the position 31c is also displayed on the map 31. To make it possible to display thus, the image information of the store guidance screen (viii) sent from the item management server 3 includes position information, and the position 31c of the cellular phone 1 on the map 31 is set on the basis of the position information of the cellular phone 1 detected by the GPS 20.

Incidentally, when map information can be acquired from another server by the cellular phone 1, the map information may be acquired on the basis of the position information of the chosen store acquired from the item management server 3. Then, the position information of the store is added to the acquired map information so as to be displayed as the store guidance screen (viii). In this case, the position of the cellular phone 1 obtained by the GPS 20 may be indicated on the map 31 displayed in the store guidance screen (viii).

When the menu item “3. display customer homepage” is chosen in the maker homepage screen (v), image information is sent from the customer homepages 4a and 4b (FIG. 3), and a customer homepage screen (ix) is displayed in the display screen 12a. In this customer homepage screen (ix), information about use conditions of the customer “B” (for example, information such as use impressions or maintenance) about the item having the same item model number as the article from which the terminal owner “A” reads the tag information, self-introduction information of the customer such as other recommended items (introduction of the recommended items or the like), hobbies, and so on, are displayed. Further, when the item management server 3 stores item information about new items in the maker database 3a, item information or advertising information of the new items may be sent to the customer homepage 4 so as to be supplied to the terminal owner “A”.

Incidentally, when the menu item “4. return” is chosen in the maker homepage screen (v), or when the menu item “1. return” is chosen in the respective screens (vi) to (ix), the routine of process returns to Step 101, and the display state is brought back to the menu screen (i).

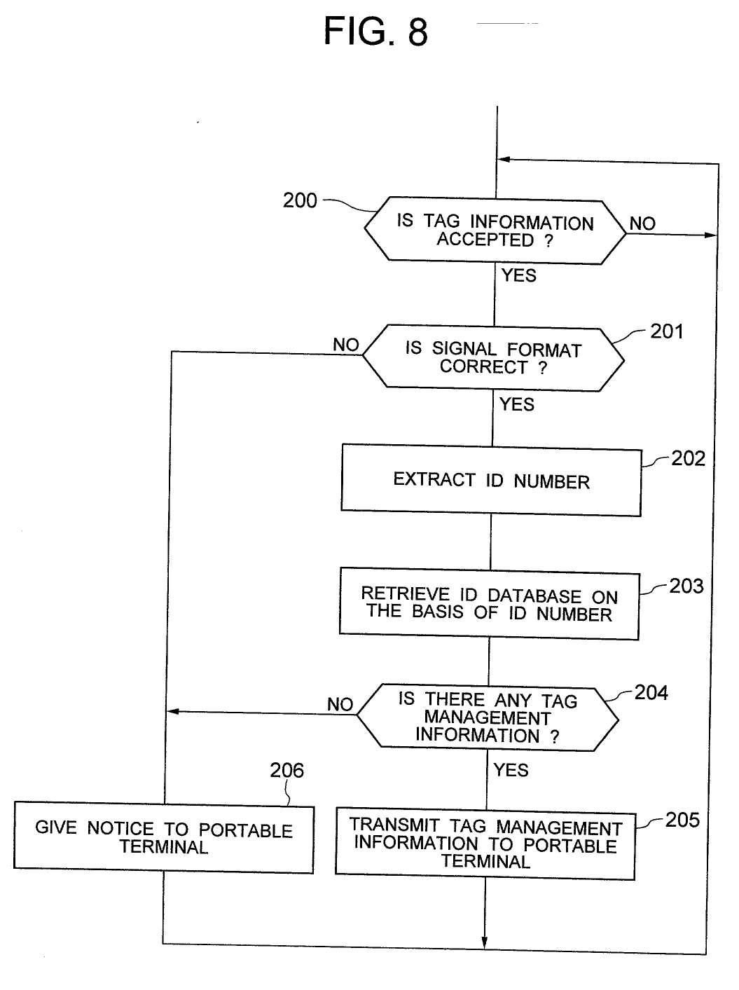

FIG. 8 is a flow chart showing a specific example of the operation of the tag management server 2 in FIG. 1.

In FIG. 8, when the tag management server 2 accepts tag information from the cellular phone 1 (Step 200), the tag management server 2 judges whether this tag information has a correct signal format (signal format conformable to this system) or not (Step 201). If the format is not conformable, the tag management server 2 regards the accepted information as not tag information, gives a notice of the fact to the cellular phone 1 (Step 206) and returns to a standby mode (Step 200). If the format is conformable, the tag management server 2 extracts an ID number from the accepted tag information (Step 202), and retrieves tag management information corresponding to this ID number from the ID database 2a (Step 203). When the corresponding tag management information cannot be retrieved (Step 204), the tag management server 2 regards the accepted tag information as not legitimate tag information, gives a notice of the fact to the cellular phone 1 (Step 206), and returns to the standby mode (Step 200). If the corresponding tag management information is present (Step 204), the tag management server 2 sends this retrieved tag management information to the cellular phone (Step 205), and returns to the standby mode (Step 200).

Thus, the terminal owner “A” can acquire item information of the article the terminal owner “A” is interested in. Such articles may include not only articles displayed in stores but also articles actually worn or carried by people or installed indoors or on the street. Further, in the case of an article worn or carried by a person, the person may walk or move. Even when the article is in such a state, the portable terminal 1 can read tag information from the ID tag 6 attached to the article. Accordingly, even if an interesting article is used actually by someone, the item information of the article can be acquired at that moment. Thus, when the terminal owner “A” touches an article in real use and has an interest in the article, the terminal owner “A” can acquire the item information of the article at once, and further can purchase an article the same as the interesting article.

Incidentally, the ID database 2a stores not only tag management information of ID tags 6 attached to articles S on sale but also tag management information of ID tags 6 attached to all of articles 5 sold out. In the same manner, the maker database 3a stores not only item information of articles 5 on sale but also item information of all of articles 5 sold out. As a result, the terminal owner “A” can acquire item information of any item already purchased and used.

In addition, ID tags 6 are managed in the tag management server 2 by a management company which is a maker of the ID tags 6. For this reason, each ID tag 6 may store, as tag information, minimum information required for the management in the tag management server 2, that is, the ID number of an article 5 and the inquiry URL of the tag management server. Accordingly, the storage capacity of the ID tag 6 does not have to be increased exceptionally; nevertheless the ID tag 6 has a storage capacity enough to store an ID number whose digit number is exceptionally larger than that of bar codes. As a result, ID tags 6 different in maker can be provided with ID numbers different in accordance with articles. Incidentally, the amount of information for the inquiry URL of the tag management server is insignificant because the number of makers of ID tags is finite.

Here, it can be considered that the system is designed so that the cellular phone 1 can make an inquiry of item information directly to the item management server 3, without intermediation of the tag management server 2 described above, as soon as the cellular phone 1 reads tag information from the ID tag 6 of an article 5. To this end, however, the ID tag 6 has to store information such as tag management information shown in FIG. 2, particularly a maker database URL for gaining access to the item management server 3. On the other hand, the information stored in the ID tag 6 can be read easily by those who have knowledge of the technology. Accordingly, those who can acquire the maker database URL can gain unauthorized access directly to the item management server 3 so as to acquire and use item information in the item management server 3 illegitimately.

The tag management server 2 can prevent such illegitimacy and protect the item management server 3 from being accessed directly from the outside. The tag management server 2 can identify whether accepted information comes from the ID tag 6 or not, on the basis of whether the ID number of the accepted information is an ID number managed by the tag management server 2. Then, the tag management server 2 allows access from the outside (the cellular phone 1 in this case) to the item management server 3 only when such an ID number is accepted. Thus, unauthorized direct access to the item management server 3 can be protected.

Further, in response to the ID number of tag information from the cellular phone 1, the tag management server 2 supplies the cellular phone 1 with the maker name of the article 5 corresponding to the tag information. Accordingly, the terminal owner “A” interested in the article 5 can choose whether the terminal owner “A” makes a request for item information by this maker name before acquiring item information of the article. Thus, the article whose item information is desired by the terminal owner “A” can be clarified.

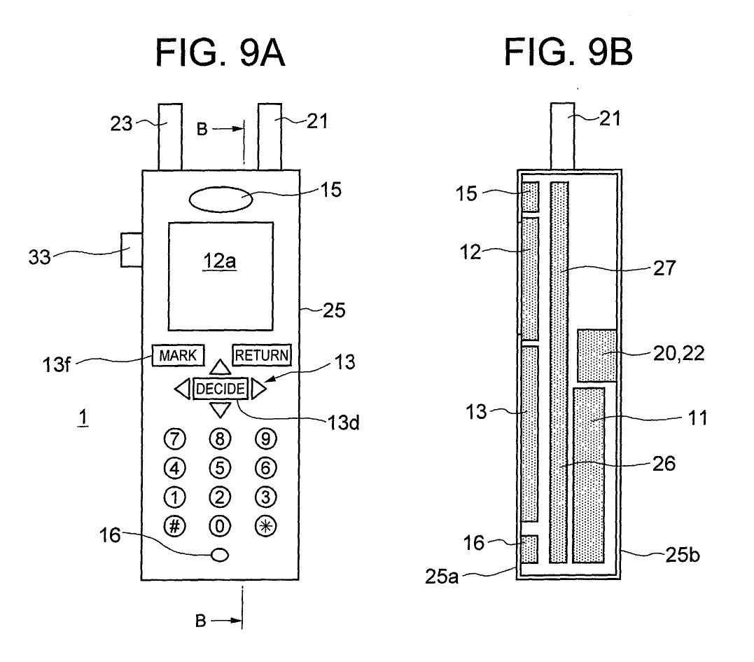

FIGS. 9A and 9B are constructional views showing a specific example of a portable terminal in another embodiment of an information acquiring/utilizing system according to the present invention. In FIGS. 9A and 9B, the reference numeral 13f represents a time mark button; 21a, an omnidirectional (nondirectional) ID tag reading antenna; and 33, an ID acquiring slide switch. Parts equivalent to those in FIGS. 4A, 4B and 4C are referenced correspondingly, and repeated description thereof will be omitted. Incidentally, also in this second embodiment, description will be made on the assumption that the portable terminal 1 is a cellular phone having the circuitry shown in FIG. 3. In addition, the system configuration and various pieces of information are similar to those in FIGS. 1 and 2.

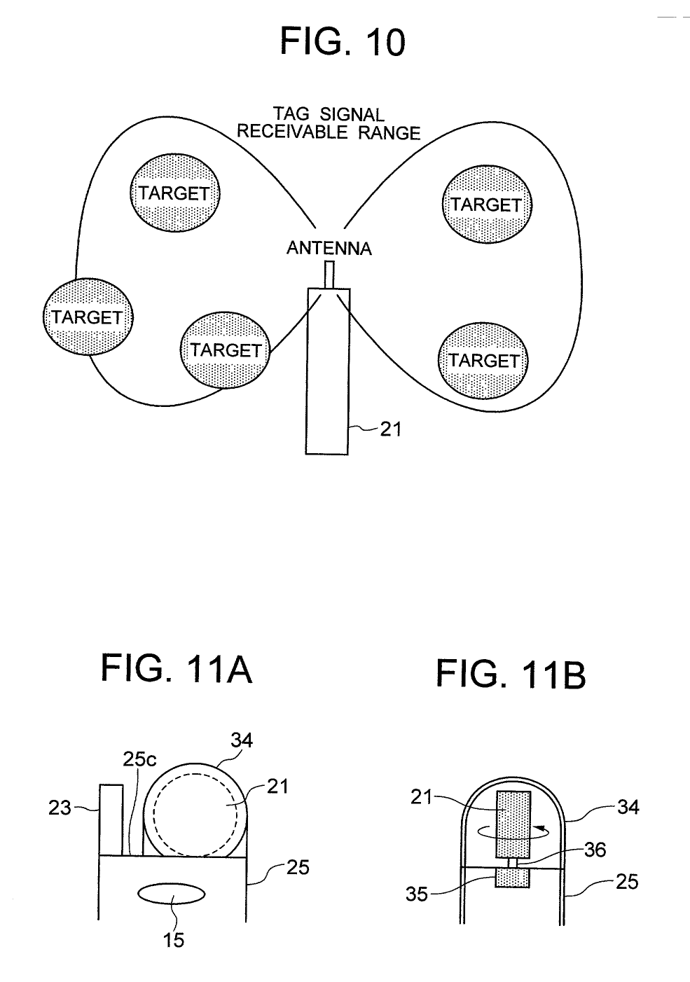

In FIGS. 9A and 9B, the horizontally omnidirectional antenna 21a, for example, a vertical dipole antenna as shown in FIG. 10, is used as the ID tag reading antenna of the cellular phone 1. The internal circuitry of the cellular phone 1 is similar to that shown in FIG. 3. Accordingly, a radio wave for reading ID tags is radiated from the ID reading antenna 21a to all the circumferential spaces, and transmitted to ID tags 6 which are in transmissible/receivable distances from the ID reading antenna 21a. The respective ID tags 6 receiving this radio wave transmit their tag information to the cellular phone 1.

The ID acquiring switch 33 is provided on the housing 25 of the cellular phone 1, for example, on the left side face thereof. In addition, the time mark button 13f is provided in the operating portion 13. When this ID acquiring switch 33 is operated, the cellular phone 1 is set into a tag information reading mode for reading ID tags 6 for a predetermined time, and a radio wave is radiated omnidirectionally from the ID reading antenna 21a. As a result of the radiation of the radio wave, tag information transmitted from ID tags 6 existing in the circumferential spaces is received sequentially by the ID reading antenna 21a, and stored sequentially in the storage portion 17 (FIG. 3). When the predetermined time has passed, the tag information reading mode is released. The tag information acquired for the predetermined time is saved in the storage portion 17.

Alternatively, the tag information reading mode may be set continuously as long as the ID acquiring switch 33 is in operation. In this case, tag information read during the mode set on is stored and saved in the storage portion 17.

FIGS. 11A and 11B are views showing another specific example of the ID reading antenna 21 used in the cellular phone 1 shown in FIGS. 9A and 9B. In FIGS. 11A and 11B, the reference numeral 25c represents an upper face of the housing 25; 34, a cover; 35, a rotating mechanism; and 36, a rotating shaft. Parts equivalent to those in FIGS. 9A and 9B are referenced correspondingly.

In FIGS. 11A and 11B, an ID reading antenna 21 made of a disc-like member is used in this special example. The ID reading antenna 21 is disposed on the upper face of the housing 25 provided with a radio communication antenna 23. The ID reading antenna 21 is attached to the rotating mechanism 35 through the rotating shaft 36 which is parallel to the radial direction of the transmission/reception plane of a radio wave (therefore, perpendicular to the upper face 25c of the housing 25), so that the transmission/reception plane of the radio wave becomes perpendicular to the upper face 25c of the housing 25. Thus, the ID reading antenna 21 is attached rotatably around a rotational axis perpendicular to the upper face 25c of the housing 25. In addition, the ID reading antenna 21 attached thus is covered with the cover 34 through which radio waves pass.

The ID reading antenna 21 is an antenna having directivity as described in FIG. 5B, but the ID reading antenna 21 becomes an omnidirectional antenna when the ID reading antenna 21 is rotated by the rotating mechanism 35.

When the ID reading switch 33 is operated, the rotating mechanism 35 is activated for the aforementioned predetermined time or during the period when the ID reading switch 33 is operated. Thus, the ID reading antenna 21 rotates and transmits a radio wave to ID tags 6 within a transmissible/receivable range in all the circumferential spaces, and receives tag information transmitted from the ID tags 6 in response to the radio wave. Thus, in the same manner as in the case where the omnidirectional ID reading antenna 21 as shown in FIG. 10 is used, the tag information can be read from the ID tags 6 within the transmissible/receivable range in all the circumferential spaces, and stored in the storage portion 17.

An omnidirectional antenna is used as the ID reading antenna 21 in this embodiment. Although specific examples thereof were shown in FIGS. 10, 11A and 11B, the ID reading antenna 21 is not limited to those specific examples. Not to say, other omnidirectional antennas may be used.

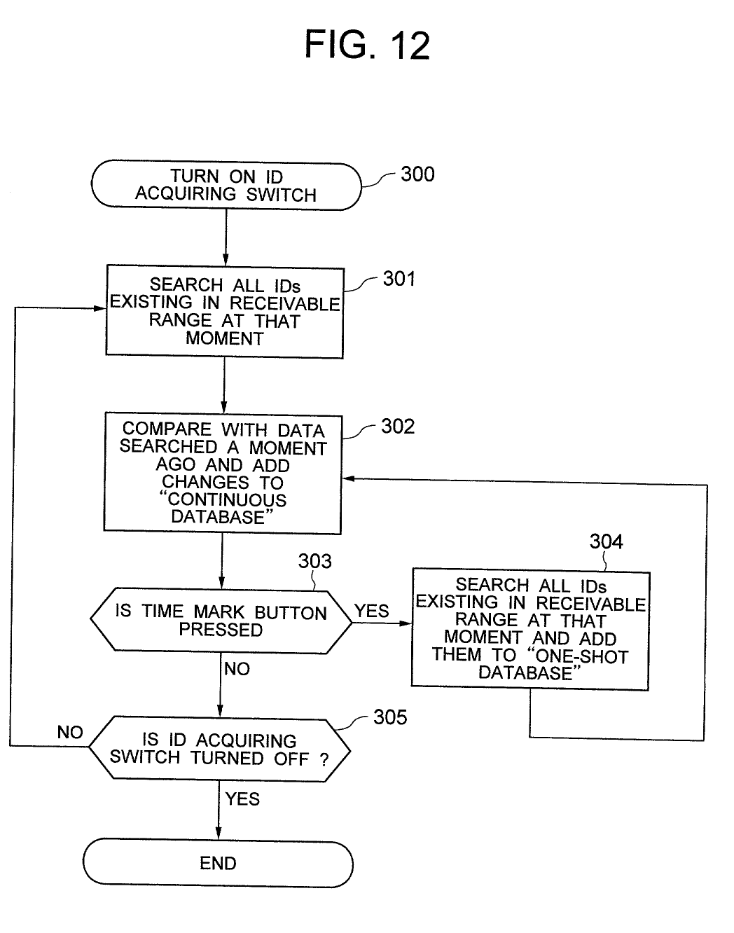

Next, a specific example of the operating procedure of the cellular phone 1 with such an ID reading antenna 21 configured as shown in FIGS. 9A and 9B will be described with reference to the flow chart shown in FIG. 12. Here, assume that tag information is detected during the ON period of the ID acquiring switch 33.

In FIG. 12, when the ID acquiring switch 33 is operated in an ON state (Step 300), a radio wave is radiated from the omnidirectional ID reading antenna 21, and the cellular phone 1 is brought into the tag information acquiring mode. When tag information transmitted from ID tags 6 within the transmissible/receivable range in all the circumferential spaces of the ID reading antenna 21 is received (Step 301), ID numbers of the ID tags 6 are stored in a continuous database of the storage portion 17 (FIG. 3) (Step 302). At this time, it is judged whether each tag information is received newly or not, and whether each tag information is missed or not. The newly received tag information is added with “detected date and time” information constituted by date and time information indicating the reception time from a timer not shown in FIG. 3 and present position information acquired at that time by the GPS 20. The tag information with the “detected date and time” information is stored in the continuous database. On the other hand, if the tag information that has been received before (therefore, the ID number of the tag information and the “detected date and time” information when the tag information was received for the first time have been stored in the continuous database) is missed in response to the transmission of a subsequent radio wave from the ID reading antenna 21, “missing date and time” information constituted by date and time information at that time from the timer and present position information acquired by the GPS 20 is stored in the continuous database in association with the ID number. Incidentally, tag information that has been received only once has “missing date and time” information identical to “detected date and time” information.

In such a manner, as long as the ID acquiring switch 33 is operated in an ON state (Step 305), tag information is received from ID tags 6 within the transmissible/receivable range of the ID reading antenna 21 (Step 301). Then, as described above, ID numbers of the received tag information and “detected date and time” information are stored in a continuous database. On the other hand, for missing tag information, “missing date and time” information is stored in the continuous database.

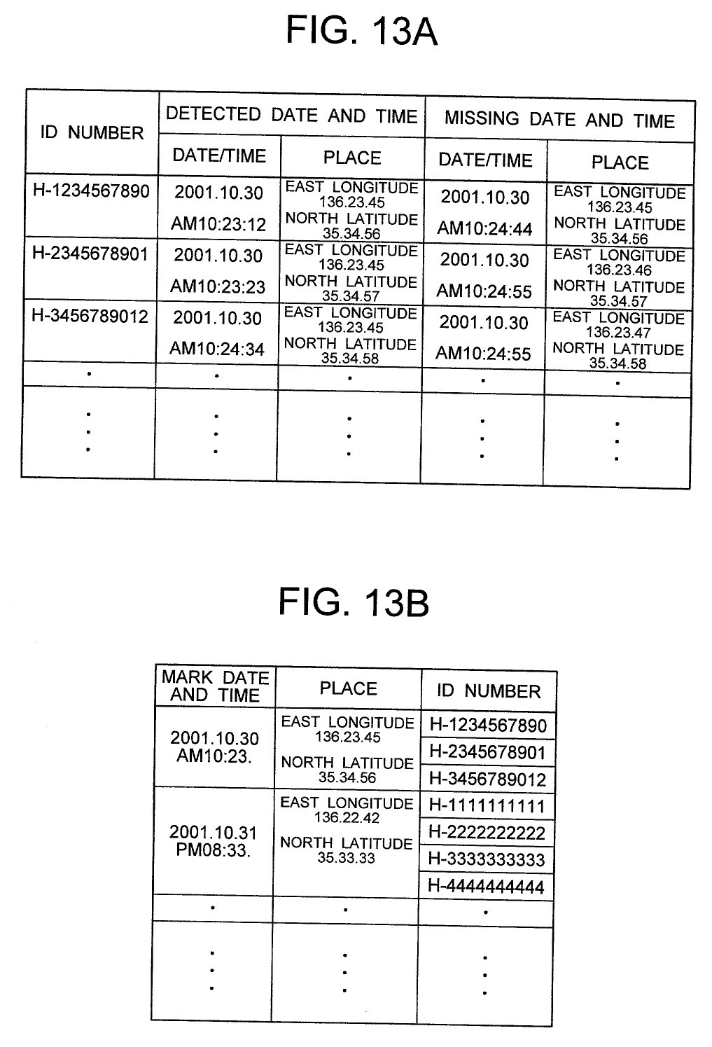

FIG. 13A is a table schematically showing a specific example of the continuous database stored thus. In FIG. 13A, ID numbers are stored sequentially in the ascending order of date and time when the ID numbers were acquired, and “detected date and time” information and “missing date and time” information are added to each ID number.

In FIG. 12, if the time mark button 13f (FIG. 9A) of the cellular phone 1 is operated (Step 303) when the cellular phone 1 is in the tag information acquiring mode in which the cellular phone 1 can receive tag information in such a manner or even when the cellular phone 1 is not in the tag information acquiring mode, information stored in the continuous database is processed to create a one-shot database in which the information are rearranged in the ascending order of date and time when the information was received for the first time (this date and time is referred to as “mark date and time) (Step 304).

FIG. 13B schematically shows a specific example of the one-shot database corresponding to the continuous database shown in FIG. 13A. In this one-shot database, tag information having substantially the same mark date and time (therefore, substantially the same place) are collected together. For example, ID numbers H-1234567890, H-2345678901 and H3456789012 shown in FIG. 13A are regarded as tag information having substantially the same mark date and time, and collected as tag information acquired on the same date and time, as shown in FIG. 13B. Such a one-shot database may be always created from the whole of the continuous database when the time mark button 13f is operated. However, each tag information used for creating a one-shot database may be made distinguishable, for example, by addition of a flag. In this case, only new tag information added with no flag is processed to be added to the one-shot database that has been already formed.

Incidentally, when tag information is read for a predetermined time after the ID acquiring switch 33 is turned ON, the continuous database is created only by addition of “detected date and time” in FIG. 13A, and the one-shot database is similar to that shown in FIG. 13B.

In such a manner, a continuous database is created from received tag information in the cellular phone 1. In addition, by operating the time mark button 13f, a one-shot database is created from the continuous database. These continuous and one-shot databases are saved in the storage portion 17.

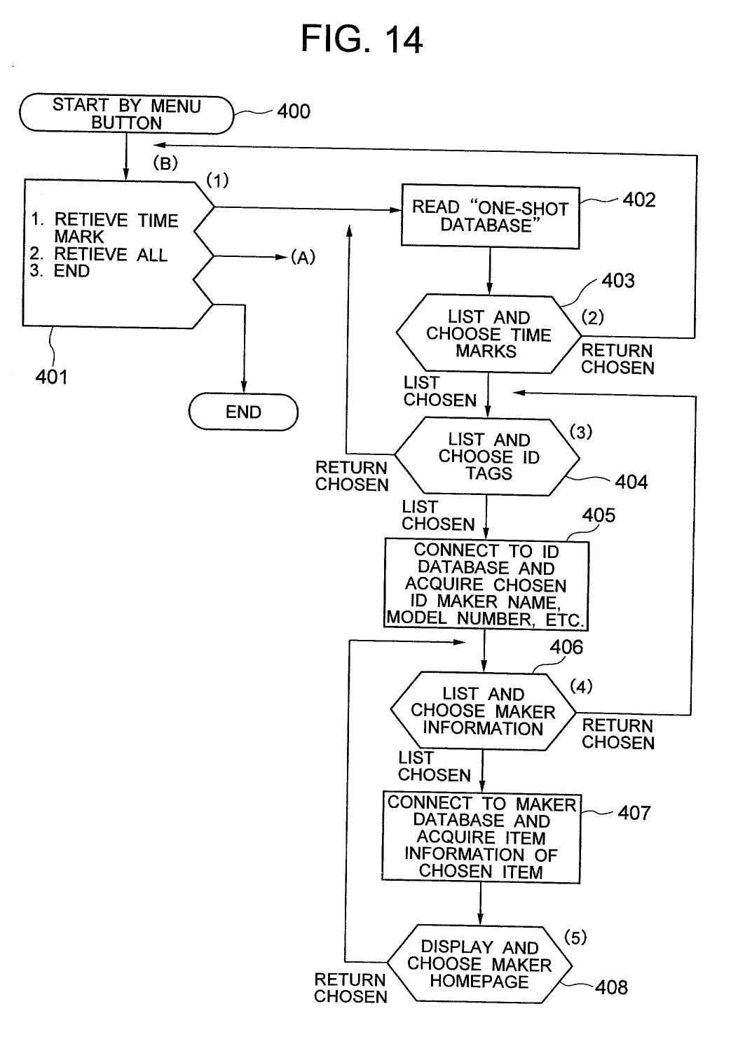

Next, with reference to FIGS. 14 to 17, description will be made on the operating procedure for acquiring item information by use of the cellular phone 1 shown in FIGS. 9A, 9B and 3 in which a continuous database or a one-shot database is stored in such a manner.

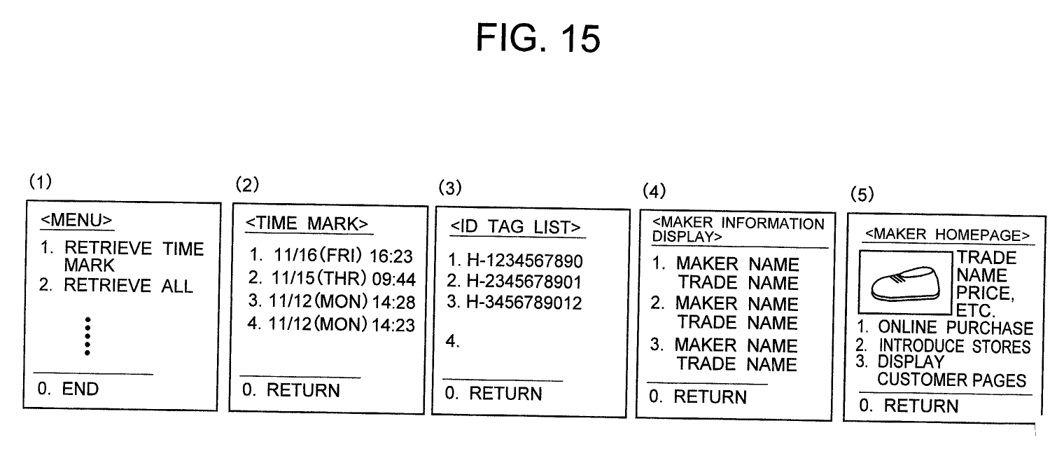

First, description will be made with reference to FIGS. 14 and 15. FIG. 14 is a flow chart showing the operating procedure when the one-shot database shown in FIG. 13B is used. FIG. 15 is a view showing specific examples of screens displayed in the display screen 12a (FIG. 9A) of the cellular phone 1 in the operating procedure of FIG. 14.

In FIGS. 14 and 15, when a not-shown menu button is operating in the operating portion 13 of the cellular phone 1 (Step 400), a menu screen (1) is displayed in the display screen 12a. In this menu screen (1), menu items “1. retrieve time mark”, “2. retrieve all”, “0. end”, and so on, can be chosen. When the menu item “1. retrieve time mark” is chosen (Step 401), the one-shot database (FIG. 13B) saved in the storage portion 17 (FIG. 3) is read, and a time mark screen (2) indicating mark date and time in the one-shot database is displayed in the display screen 12a. In this time mark screen (2), any mark date and time displayed or a menu item “0. return” can be chosen. When the menu item “0. return” is chosen, the display state returns to the menu screen (1). On the other hand, when any mark date and time is chosen (so far Step 403), ID numbers corresponding to the chosen mark date and time are retrieved from the one-shot database, and the retrieval result is displayed as an ID tag list screen (3) in the display screen 12a. In this ID tag list screen (3), any ID number or a menu item “0. return” can be chosen. When the menu item “0. return” is chosen, the routine of process returns to Step 102 so that the display state returns to the time mark screen (2) again. On the other hand, when any one of the ID numbers is chosen (so far Step 404), the chosen ID number is sent to the tag management server 2 (FIG. 1) together with an inquiry URL. Incidentally, by choosing the menu item “4. choose all items”, all the ID numbers displayed can be chosen and sent to the tag management server 2 in a lump.

The tag management server 2, for example, operates as shown in FIG. 8, so as to retrieve tag management information corresponding to the received ID numbers from the ID data base 2a, and send the retrieved tag management information to the cellular phone 1 (Step 405). As a result, a maker information display screen (4) showing a maker name and a trade name for every chosen ID number is displayed in the display screen 12a. Also in this maker information display screen (4), the menu item “0. return” can be chosen. When the menu item “0. return” is chosen, the display state returns to the ID tag list screen (3). On the other hand, when any one of the maker names is chosen (so far Step 406), an inquiry is made to the item management server 3 (FIG. 1) in the same manner as in the first embodiment so that corresponding item information is supplied (Step 407). Then, a maker homepage screen (5) is displayed in the display screen 12a (Step 408). This maker homepage screen (5) is similar to that in the first embodiment described in FIG. 6.

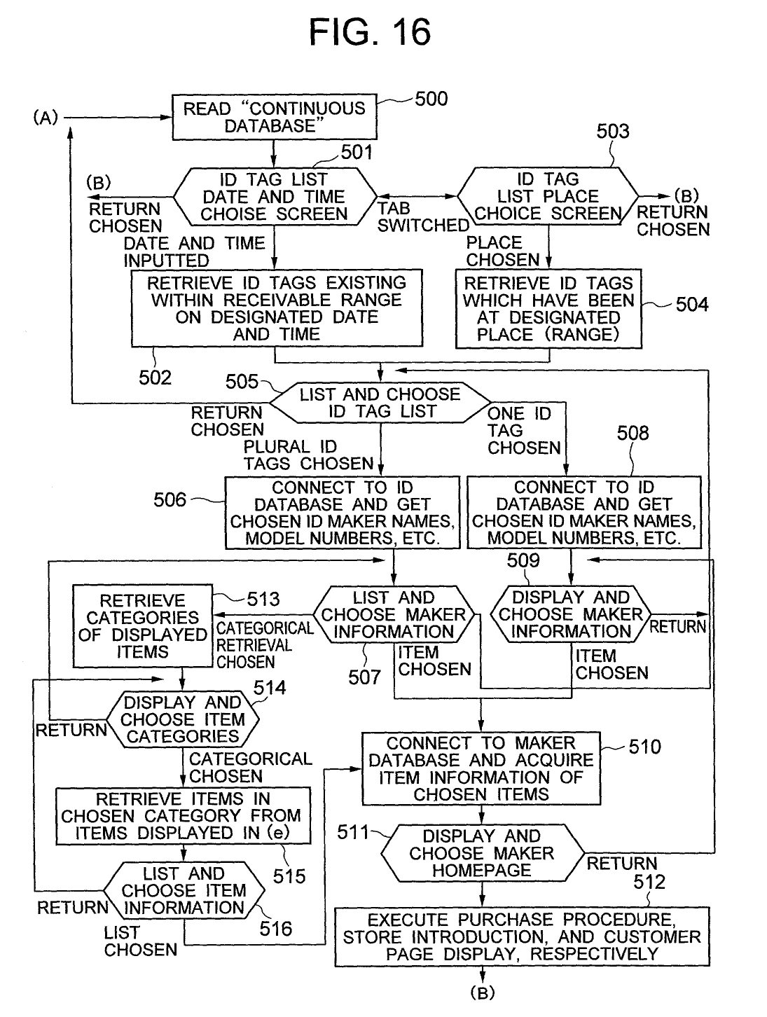

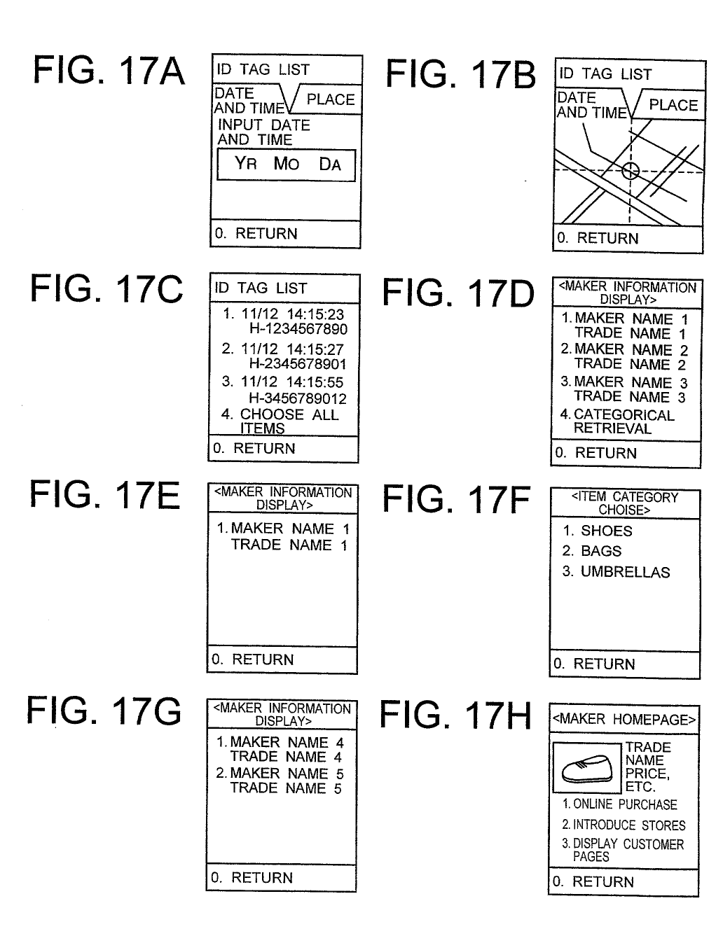

Next, with reference to FIGS. 16 and 17, description will be made on the case where the continuous database saved in the storage portion 17 of the cellular phone 1 is used.

This is carried out when the menu item “2. retrieve all” is chosen in Step 401 (menu screen (1) in FIG. 15). FIG. 16 shows the operating procedure, and FIG. 17 shows screens displayed in the display screen 12a at this time.

When the menu item “2. retrieve all” is chosen in the menu screen (1) shown in FIG. 15 (Step 401 in FIG. 14), the continuous database (FIG. 13A) saved in the storage portion 17 (FIG. 3) is read in FIGS. 16 and 17 (Step 500). Then, an input screen (a) for inputting a desired date and time or a desired place is displayed in the display screen 12a (Step 501). When the menu item “date and time” is chosen in the input screen (a) and a desired date is inputted, ID numbers corresponding to the desired date are retrieved from the continuous database (Step 502), and an ID tag list screen (c) showing a list of the corresponding ID numbers is displayed in the display screen 12a (Step 505). On the other hand, when the menu item “place” is chosen in the input screen (a), a map screen (b) showing a map is displayed in the display screen 12a (Step 503). A map of a desired place can be selectively displayed in the map screen (b). When a desired place is designated on the map, ID numbers having position information near the designated place are retrieved from the continuous database (FIG. 13A) (Step 504), and an ID tag list screen (c) showing a list of the corresponding ID numbers is displayed in the display screen 12a (Step 505).

Incidentally, when the menu item “return” is chosen in the input screen (a), the map screen (b) or the ID tag list screen (c), the routine of process returns to Step 401 in FIG. 14.

In the ID tag list screen (c), individual ID numbers can be chosen, or the menu item “4. choose all items” can be checked to choose all the displayed ID numbers together. When one desired ID number is designated, tag management information (FIG. 2) corresponding to the designated ID number is supplied from the tag management server 2 (FIG. 1) in the same manner as in the first embodiment (Step 508). Then, a maker information display screen (e) showing the maker name and the trade name of the ID number is displayed in the display screen 12a (Step 509). On the other hand, when the menu item “4. choose all items” is chosen in the ID tag list screen (c) (Step 505), tag management information corresponding to all the displayed ID numbers can be acquired from the tag management server 2 (Step 506). Then, a maker information display screen (d) showing the maker names and the trade names corresponding to these ID numbers respectively is displayed in the display screen 12a (Step 507). Incidentally, when the menu item “0. return” is designated in the maker information display screen (d) or (e), the routine of process returns to Step 505 in which the ID tag list screen (c) is displayed.

When one maker name is designated in the maker information display screen (d) or (e) (Step 507 or 509), corresponding item information is supplied from the item management server 3 (FIG. 1) in the same manner as in the first embodiment (Step 510). Then, a maker homepage screen (h) is displayed (Step 511), and an operation similar to that in Step 108 in FIG. 6 can be carried out (Step 512).

Further, a menu item “4. categorical retrieve” can be chosen in the maker information display screen (d) obtained as the result of the menu item “4. choose all items” chosen in the ID tag list screen (c). When the menu item “4. categorical retrieve” is chosen (Step 507), tag management information supplied from the tag management server 2 is used (Step 513) so that an item category choice screen (f) showing a list of item categories of the ID numbers displayed in the maker information display screen (d) is displayed in the display screen 12a (Step 514). When a desired category is designated from this list, maker information of items corresponding to the designated categories are retrieved from the maker information displayed in the maker information display screen (d) (Step 515). Then, the retrieval result is displayed as a maker information display screen (g) in the display screen 12a (Step 516). When one of the retrieved maker information is designated, the routine of process goes to the operation from Step 510 so that item information can be obtained.

Incidentally, when the menu item “0. return” is chosen in the item category choice screen (f) (Step 514), the routine of process returns to Step 504. When the menu item “0. return” is chosen in the maker information display screen (g) (Step 516), the routine of process returns to Step 514. When the menu item “0. return” is chosen in the maker homepage screen (h) (Step 511), the routine of process returns to original Step 507 or 509.

In such a manner, in this second embodiment, when the terminal owner “A” goes out, for example, takes a walk on a street or meets somebody by appointment in a station, the terminal owner “A” can acquire tag information from interesting articles such as clothes or shoes worn or carried by other persons. In this case, tag information of articles other than the interesting articles are acquired indiscriminately. By selecting tag information of really interesting articles, item information of the interesting articles can be supplied.

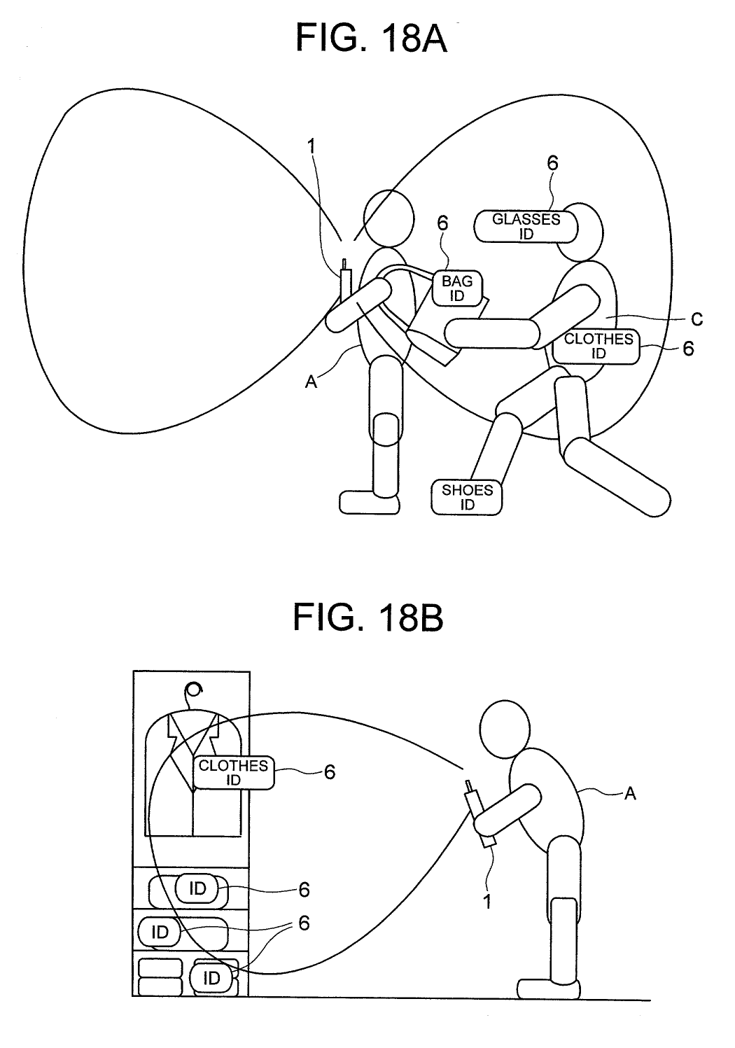

FIGS. 18A and 18B are views of other examples of applications of the second embodiment.

In FIG. 18A, the cellular phone 1 is used for a supervisory system against theft such as snatching. If the ID acquiring switch 33 (FIGS. 9A and 9B) is turned ON when an article is stolen, not only the ID tag 6 of the stolen article (in this case, not to say, the tag information of the stolen article has been saved in the cellular phone 1) but also ID tags 6 of articles worn by the theft can be read. The stolen article and the articles (clothes and the like) worn by the theft can be known by acquiring item information of the ID tags 6 read thus.

In FIG. 18B, the cellular phone 1 is used for a supervisory system for looking for something due to leaving behind or the like. Also in this case, tag information of articles of the terminal owner “A” have been saved in the cellular phone 1. When the terminal owner “A” has a general idea of the place where an article was left behind, the terminal owner “A” goes to that place or a lost and found office or the like and turns ON the ID acquiring switch 33 of the cellular phone 1. As a result, the cellular phone 1 reads ID tags 6 around the cellular phone 1. If the tag information of one of the read ID tags 6 is in agreement with the saved tag information as a result of comparison, there is a probability that the lost article is present in that place. When the lost article is, for example, a casing such as a bag, ID tags of articles received in the casing are also read. When of a plurality of pieces of the read tag information are in agreement with pieces of the saved tag information, the probability that the casing is of the terminal owner “A's” belonging increases.

Further, the second embodiment can be applied to a management system for looking for lost children in an amusement park or the like. In this case, ID tags of articles worn by a child are used. The tag information of these ID tags has been saved in a cellular phone carried by the child's parent. On the other hand, gates for reading ID tags are provided in predetermined places respectively in the amusement park or the like. When a child is lost, the lost child's parent notifies a management department of such saved tag information of ID tags by radio communication or the like. The management department transmits the tag information to the respective gates so as to designate the tag information. Each of the gates always reads ID tags of articles of customers passing through the gate. When the designated tag information is read, the gate regards that the lost child has passed through the gate, and gives a notice to the management department. The management department transmits information indicating the place of the gate to the cellular phone of the parent.

Thus, the second embodiment can be applied to various supervisory systems.

As described above, according to a tag management server of the present invention, tag management information associated with only ID tags managed by the tag management server can be provided. Thus, predetermined information can be provided while ID tags can be managed.

In addition, according to an information acquiring/utilizing system of the present invention, a terminal owner can easily acquire item information of articles sold and already used by other persons regardless of place and without asking others. Thus, the terminal owner can obtain item information of articles judged as preferred on the basis of impressions of articles in actual use, the impressions being different from impressions when the same articles are displayed in stores.

Moreover, in response to an inquiry from a portable terminal, the tag management server supplies the portable terminal with tag management information including maker names and so on of articles. When a large number of ID tags are read, the terminal owner can determine whether it is the item information that the terminal owner desires to acquire on the basis of such tag management information. Thus, the terminal owner can quickly acquire only item information of articles the terminal owner is really interested in.

Further, customers can acquire item information easily. Accordingly, advertising effects are expanded on the maker side or seller side of the items. Thus, purchase channels are expanded, and consumption or circulation of the items is activated.

It should be further understood by those skilled in the art that the foregoing description has been made on embodiments of the invention and that various changes and modifications may be made in the invention without departing from the spirit of the invention and the scope of the appended claims.

What is claimed is:

1. A tag management server for providing tag management information corresponding to tag information read from an ID tag in response to an inquiry using said tag information, comprising:
a database for storing tag management information corresponding to respective ID tags; wherein:
said tag management server judges whether said inquiry is legitimate or not, based on tag information corresponding to an ID tag managed by said tag management server;
said tag management server retrieves tag management information corresponding to said tag information used in said legitimate inquiry from said database; and
when said corresponding tag management information is retrieved, said tag management server supplies said tag management information to an inquirer, and when said inquiry is not legitimate or when corresponding tag management information is not retrieved, said tag management server gives a notice of the fact to said inquirer.

2. A tag management server according to claim 1, wherein:
said tag management information includes, for every managed ID tag, a maker and a trade name of an article provided with said ID tag.

3. An information acquiring/utilizing system comprising:
a portable terminal for reading tag information from an ID tag provided in an article via radio waves;
a tag management server; and
an item management server; wherein:
said portable terminal makes an inquiry to said tag management server on the basis of tag information read from said ID tag, while said tag management server supplies corresponding tag management information to said portable terminal in response to said inquiry from said portable terminal; and
said portable terminal makes an inquiry to said item management server on the basis of said tag management information acquired from said tag management server, while said item management server supplies said portable terminal, in response to said inquiry from said portable terminal, with item information about an article provided with said ID tag from which said portable terminal acquires said tag information.

4. An information acquiring/utilizing system according to claim 3, wherein:
said portable terminal includes an antenna having directivity for reading tag information from said ID tag.

5. An information acquiring/utilizing system according to claim 3, wherein:
said portable terminal includes a non-directional antenna for reading tag information from said ID tag.

6. An information acquiring/utilizing system according to claim 5, wherein:
said portable terminal includes an operating button for reading tag information from said ID tag, and when said operating button is operated, said portable terminal reads tag information of said ID tag existing within a predetermined distance for a predetermined time.

7. An information acquiring/utilizing system according to claim 5, wherein:
said portable terminal includes an operating button for reading tag information from said ID tag, and said portable terminal reads tag information of said ID tag existing within a predetermined distance during a period when said operating button is in an operating state.
